(19) United States
(12) Patent Application Publication
(10) Pub. No.: US 2026/0148388 A1
(43) Pub. Date: May 28, 2026

(54) IMAGE SPACE REGISTRATION FOR INSTRUMENT NAVIGATION

(71) Applicant: Auris Health, Inc., Santa Clara, CA (US)

(72) Inventors: Naeim Bahrami, San Diego, CA (US); Mali Shen, Sunnyvale, CA (US); Mohammad Matinfar, San Jose, CA (US); Jeffrey Adam Kasten, San Mateo, CA (US); Hedyeh Rafii-Tari, Mountain View, CA (US)

(73) Assignee: Auris Health, Inc., Santa Clara, CA (US)

(21) Appl. No.: 19/402,341

(22) Filed: Nov. 26, 2025

Related U.S. Application Data
(60) Provisional application No. 63/726,138, filed on Nov. 27, 2024.

(51) Int. Cl. G06T 7/00; G06T 7/174; G06T 7/32; G06T 11/00

(52) U.S. Cl. CPC G06T 7/0014; G06T 7/174; G06T 7/32; G06T 12/30; G06T 2207/10081; G06T 2207/20084

(57) ABSTRACT

This disclosure provides methods, devices, and systems for navigating medical instruments. The present implementations more specifically relate to image space registration techniques for instrument navigation. A controller for a medical system receives a first three-dimensional (3D) image of an anatomy captured by a first imaging system external to the anatomy and receives a second 3D image of the anatomy captured by a second imaging system external to the anatomy. For example, the first imaging system may be a computed tomography (CT) system and the second imaging system may be a cone beam CT (CBCT) system. In some aspects, the controller may compare the first 3D image to the second 3D image based on one or more image processing operations and may determine a mapping between a coordinate space associated with the first imaging system and a coordinate space associated with the second imaging system based on the comparison.

### CROSS-REFERENCE TO RELATED APPLICATIONS

This application claims priority and benefit under 35 U.S.C. § 119 (e) to U.S. Provisional Patent Application No. 63/726,138, filed Nov. 27, 2024, which is incorporated herein by reference in its entirety.

### TECHNICAL FIELD

This disclosure relates generally to medical systems, and specifically to image space registration for instrument navigation.

### DESCRIPTION OF RELATED ART

Many medical procedures include steps that can be performed pre-operation (also referred to as a “preoperative phase”), intra-operation (also referred to as an “intraoperative phase”), or post-operation (also referred to as a “postoperative phase”). For example, during a preoperative phase, an imaging system may be used to scan or otherwise capture images or video of a patient's anatomy. Example suitable imaging technologies include computed tomography (CT), X-ray, fluoroscopy, positron emission tomography (PET), PET-CT, CT angiography, cone beam CT (CBCT), three-dimensional rotational angiography (3DRA), single-photon emission CT (SPECT), magnetic resonance imaging (MRI), optical coherence tomography (OCT), and ultrasound, among other examples. The images may be used, during an intraoperative phase, to help guide or navigate a medical instrument to a target (also referred to as a “treatment site”) within the patient's anatomy. However, images acquired during a preoperative phase may not accurately reflect a spatial relationship between the medical instrument and the target during an intraoperative phase. For example, among various other factors, preoperative images are often acquired several days (or even weeks) before the intraoperative phase, such that changes in the patient's anatomy may cause deviations in the spatial positioning of the target. Thus, there is a need to provide more accurate information about the spatial relationship between the medical instrument and the target during the intraoperative phase.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method for registration between different coordinate spaces. The method includes steps of receiving first image data depicting a first three-dimensional (3D) image of an anatomy captured by a first imaging system external to the anatomy; receiving second image data depicting a second 3D image of the anatomy captured by a second imaging system external to the anatomy; comparing the first image data to the second image data based at least in part on one or more image processing operations; and determining a mapping between a first coordinate space associated with the first imaging system and a second coordinate space associated with the second imaging system based on comparing the first image data to the second image data.

Another innovative aspect of the subject matter of this disclosure can be implemented in a controller for a medical system, including a processing system and a memory. The memory stores instructions that, when executed by the processing system, cause the controller to receive first image data depicting a first 3D image of an anatomy captured by a first imaging system external to the anatomy; receive second image data depicting a second 3D image of the anatomy captured by a second imaging system external to the anatomy; compare the first image data to the second image data based at least in part on one or more image processing operations; and determine a mapping between a first coordinate space associated with the first imaging system and a second coordinate space associated with the second imaging system based on comparing the first image data to the second image data.

### BRIEF DESCRIPTION OF THE DRAWINGS

The present implementations are illustrated by way of example and are not intended to be limited by the figures of the accompanying drawings.

FIG. 1 shows an example medical system, according to some implementations.

FIG. 2 shows example components of the control system and the robotic system of FIG. 1, according to some implementations.

FIG. 3 shows a block diagram of an example localization system, according to some implementations.

FIG. 4A shows an example anatomical lumen that can be scanned using three-dimensional (3D) imaging technologies.

FIG. 4B shows an example anatomical model that can be reconstructed from 3D images of the anatomical lumen of FIG. 4A, according to some implementations.

FIG. 5 shows an example graphical interface for navigating an instrument to a target within an anatomy, according to some implementations.

FIG. 6 shows a block diagram of an example registration system, according to some implementations.

FIG. 7 shows an example mapping between a computed tomography (CT) image space and cone beam CT (CBCT) image space, according to some implementations.

FIG. 8 shows another example mapping between a CT image space and a CBCT image space, according to some implementations.

FIG. 9 shows another block diagram of an example registration system, according to some implementations.

FIG. 10 shows a block diagram of an example image comparison system, according to some implementations.

FIG. 11 shows a block diagram of an example machine learning system, according to some implementations.

FIG. 12 shows a block diagram of an example controller for a medical system, according to some implementations.

FIG. 13 shows an illustrative flowchart depicting an example operation for registering different coordinate spaces, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain standard anatomical terms of location may be used herein to refer to the anatomy of animals, and namely humans, with respect to the example implementations. Although certain spatially relative terms, such as “outer,” “inner,” “upper,” “lower,” “below,” “above,” “vertical,” “horizontal,” “top,” “bottom,” and similar terms, are used herein to describe a spatial relationship of one element, device, or anatomical structure to another device, element, or anatomical structure, it is understood that these terms are used herein for ease of description to describe the positional relationship between elements and structures, as illustrated in the drawings. It should be understood that spatially relative terms are intended to encompass different orientations of the elements or structures, in use or operation, in addition to the orientations depicted in the drawings. For example, an element or structure described as “above” another element or structure may represent a position that is below or beside such other element or structure with respect to alternate orientations of the subject patient, element, or structure, and vice-versa. As used herein, the term “patient” may generally refer to humans, anatomical models, simulators, cadavers, and other living or non-living objects.

In the figures, a single block may be described as performing a function or functions; however, in actual practice, the function or functions performed by that block may be performed in a single component or across multiple components, or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems or devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described herein. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, or executed by a computer or other processor.

The various illustrative logical blocks, modules, circuits and instructions described in connection with the implementations disclosed herein may be executed by one or more processors (or a processing system). The term “processor,” as used herein may refer to any general-purpose processor, special-purpose processor, conventional processor, controller, microcontroller, or state machine capable of executing scripts or instructions of one or more software programs stored in memory.

As described above, many medical procedures include a preoperative phase that precedes an intraoperative phase. During the preoperative phase, for some medical procedures, an imaging system may be used to scan or otherwise capture images or video of at least a portion of a patient's anatomy. For example, a computed tomography (CT) scanner may be used to acquire tomographic images (also referred to as “tomograms” or “CT scans”) of a patient's lungs during the preoperative phase for a bronchoscopy. A tomogram is a cross-section or slice of a three-dimensional (3D) volume. For example, multiple tomograms can be stacked or combined to recreate the 3D volume (such as a 3D model of the patient's lungs). Thus, tomograms can be used to detect a precise location or position (in 3D space) of a nodule or target in the patient's lungs. During the intraoperative phase, for some medical procedures, a medical system may use the preoperative images to generate a graphical interface for navigating a medical instrument within the patient's anatomy. For example, during a bronchoscopy, the medical system may detect a pose of an endoscope (such as a position and orientation of the scope in 3D space) based on sensor data received via one or more sensors (such as an electromagnetic (EM) sensor) disposed the scope and map the pose of the endoscope to a 3D model of the patient's lungs depicted by the tomograms.

Accordingly, the graphical interface may depict a spatial relationship between the medical instrument and the target within the anatomy based on the sensor data and the image data. However, images acquired during a preoperative phase may not accurately reflect the spatial relationship between the medical instrument and the target during an intraoperative phase. For example, changes in the patient's anatomy or the medical environment can cause the spatial relationship between the endoscope and target to deviate from what is depicted by the graphical interface at any given time, which can lead to inaccurate navigation. Example factors include EM distortion, poor registration (or mapping) between the sensor space and the image space associated with the preoperative scans (also referred to as the “preoperative image space”), outdated preoperative scans, and anatomical deformations, among other examples. Aspects of the present disclosure recognize that some modern imaging technologies (such as cone beam CT) can be used to scan a patient's anatomy during an intraoperative phase. In some aspects, a medical system may capture updated images of the patient's anatomy during the intraoperative phase and use the updated image data to improve the representation of the spatial relationship between the medical instrument and the target. The updated image data and sensor data are often associated with different coordinate spaces. Thus, in some implementations, the medical system may “register” the updated image space with the sensor space to facilitate real-time navigation.

As used herein, the term “registration” refers to a mapping or transformation between different coordinate spaces. For example, a medical system (or registration system associated therewith) may register an imaging system used for capturing images of a patient's anatomy (such as a CT imaging system or cone beam CT (CBCT) imaging system) with a sensor system used for tracking a pose of a medical instrument within the anatomy (such as an EM field generator) by determining a mapping or spatial transformation that maps any point or vector in the image space to a respective point or vector in the sensor space (such as a transformation matrix). The terms “mapping,” “transformation,” “spatial transformation,” and “registration matrix,” may be used interchangeably herein. The terms “respective” and “corresponding” also may be used interchangeably herein.

Although certain aspects of the present disclosure are described in detail herein in the context of bronchoscopy, it should be understood that the systems and techniques of the present disclosure may be applicable to any medical procedure. Example medical procedures may include minimally invasive procedures (such as laparoscopy), non-invasive procedures (such as endoscopy), therapeutic procedures, diagnostic procedures, percutaneous procedures, and non-percutaneous procedures, among other examples. Example endoscopic procedures include bronchoscopy, ureteroscopy, gastroscopy, nephroscopy, and nephrolithotomy, among other examples. The terms “scope,” “endoscope,” “catheter,” and “instrument” may be used interchangeably herein.

Aspects of the present disclosure may be used to perform robotic-assisted medical procedures, such as endoscopic access, percutaneous access, or treatment for a target anatomical site. For example, robotic tools may engage or control one or more medical instruments (such as an endoscope) to access a target site within a patient's anatomy or perform a treatment at the target site. In some implementations, the robotic tools may be guided or controlled by a physician. In some other implementations, the robotic tools may operate in an autonomous or semi-autonomous manner. Although systems and techniques are described herein in the context of robotic-assisted medical procedures, the systems and techniques may be applicable to other types of medical procedures (such as procedures that do not rely on robotic tools or only utilize robotic tools in a very limited capacity). For example, the systems and techniques described herein may be applicable to medical procedures that rely on manually operated medical instruments (such as an endoscope that is exclusively controlled and operated by a physician). The systems and techniques described herein also may be applicable beyond the context of medical procedures (such as in simulated environments or laboratory settings, such as with models or simulators, among other examples).

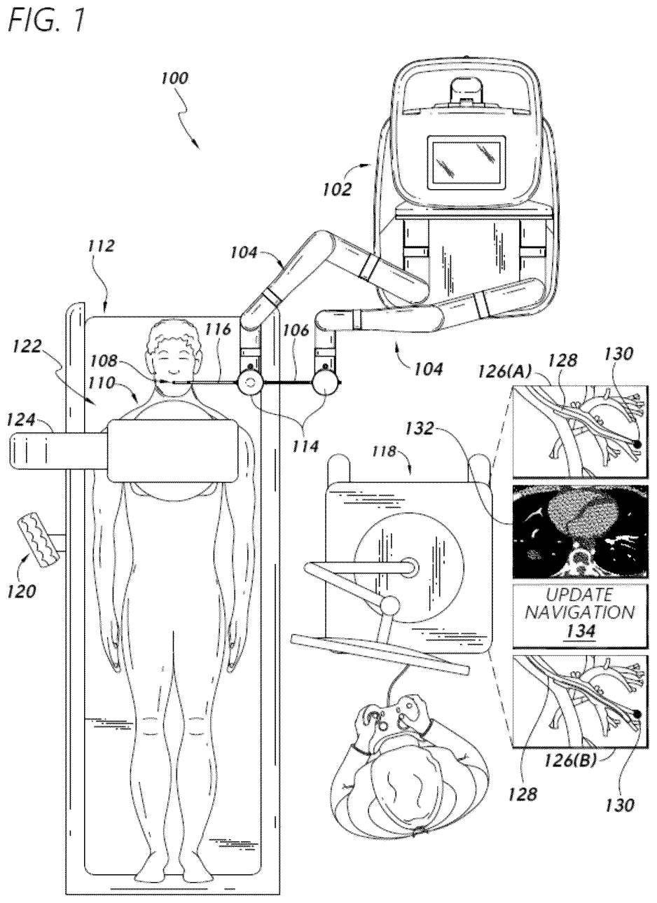

FIG. 1 shows an example medical system 100 (also referred to as a “surgical medical system” or a “robotic medical system”), according to some implementations. As shown in FIG. 1, the medical system 100 may be arranged for diagnostic or therapeutic bronchoscopy. The medical system 100 can include and utilize a robotic system 102 which can be implemented, for example, as a robotic cart. Although the medical system 100 is shown as including various cart-based systems or devices, the concepts disclosed herein can be implemented in any type of robotic system or arrangement, such as robotic systems employing rail-based components, table-based robotic end-effectors, or manipulators, among other examples. The robotic system 102 may include one or more robotic arms 104 (also referred to as “robotic positioners”) configured to position or otherwise manipulate a medical instrument 106 (such as a steerable endoscope or another elongate instrument). For example, the medical instrument 106 can be advanced through a natural orifice access point (such as the mouth 108 of a patient 110 positioned on a table 112) to deliver diagnostic or therapeutic treatment. Although described in the context of a bronchoscopy procedure, the medical system 100 also may be used to perform other types of medical procedures. Example suitable procedures include gastro-intestinal (GI) procedures, renal procedures, urological procedures, and nephrological procedures, among other examples.

With the robotic system 102 properly positioned, the medical instrument 106 can be inserted into the patient 110 robotically, manually, or a combination thereof. For example, the one or more robotic arms 104, or instrument drivers 114 coupled thereto, can control the medical instrument 106. In some implementations, the medical instrument 106 may be advanced within a sheath 116. For example, the sheath 116 may be coupled to, or controlled by, a robotic arm 104. In some implementations, the medical instrument 106 and the sheath 116 may each be coupled to a respective instrument driver from a set of instrument drivers 114. The instrument drivers 114 can be repositionable in space by manipulating the one or more robotic arms 104 into different angles or positions.

In the example of FIG. 1, the medical instrument 106 can be directed down the patient's trachea and lungs after insertion or advanced to a target destination or operative site. In some implementations, to enhance navigation through the patient's lung network or reach the desired target, the medical instrument 106 may be manipulated to telescopically extend from the outer sheath 116 to obtain enhanced articulation or greater bend radius. The use of separate instrument drivers 114 can allow the medical instrument 106 and sheath 116 to be driven independently of each other.

In some implementations, the medical instrument 106 may include an elongate member or shaft configured to be inserted or retracted, articulated, or otherwise moved within the anatomy. Further, in some implementations, the medical instrument 106 may include one or more imaging devices (such as cameras) positioned on a distal end of the elongate shaft or deployed through a working channel of the elongate shaft. The imaging devices can be configured to generate or capture image (or video) data or send the image data to another device or component. In some implementations, the medical instrument 106 may include an instrument base or one or more handles positioned at a proximal end of the medical instrument 106. The instrument base can be coupled to a manipulator (such as an end of a robotic arm 104). The instrument base can include one or more drive inputs coupled to one or more drive outputs of the manipulator, wherein the drive inputs or drive outputs act as an interface.

In some implementations, the medical instrument 106 may include a working channel configured to receive one or more other instruments or elements therein or provide other functionality. The working channel can extend axially, such as along the length of the medical instrument 106. Furthermore, the medical instrument 106 can include or be associated with one or more elongate movement members (such as pulls wires) that can extend from a proximal end through the elongate shaft to the distal end of the elongate shaft. The elongate movement members can be manipulated, such as by manipulators on the one or more robotic arms 104, to control actuation of the elongate movement members.

In some implementations, the medical instrument 106 may include one or more sensors, such as electromagnetic (EM) sensors, shape sensors (such as shape sensing fiber), accelerometers, gyroscopes, satellite-based positioning sensors (such as global positioning system (GPS) sensors), or radio-frequency (RF) transceivers, among other examples. The sensors can be configured to generate or produce sensor data or provide the sensor data to another device or component. The sensors can be disposed at a distal end of the elongate shaft or along a length of the elongate shaft. In some implementations, the medical instrument 106 may be configured to receive an elongate member or device through a working channel, wherein the elongate member includes one or more sensors along a length of the elongate member. One or more sensors on the medical instrument 106 may provide sensor data to control circuitry of the medical system 100, which is then used to determine a position, orientation, or shape of the medical instrument 106.

The medical system 100 can also include a control system 118 (also referred to as a “control tower” or “mobile tower”). The control system 118 can be communicatively coupled (such as via wired or wireless connections) to the robotic system 102 to control various aspects of the robotic system 102 (such as electronics, optics, sensors, or power) or one or more subsystems associated with the robotic system 102, such as a fluid management system (not shown). Placing such functionality in the control system 118 can allow for a smaller form factor of the robotic system 102 that may be more easily adjusted or re-positioned by an operator or user. Additionally, the division of functionality between the robotic system 102 and the control system 118 can reduce operating room clutter and facilitate efficient clinical workflow.

The medical system 100 can include an electromagnetic (EM) field generator 120, which is configured to broadcast or emit an EM field that can be detected by various EM sensors, such as a sensor disposed on the medical instrument 106. The EM field can induce small electric currents in coils of the EM sensors, which can be analyzed to determine a position, angle, or orientation of the EM sensors relative to the EM field generator 120. Although EM fields and EM sensors are described in many examples herein, position sensing systems or sensors can include various other types of position sensing systems or sensors, such as optical position sensing systems or sensors, image-based position sensing systems or sensors, among other examples.

The medical system 100 can further include an imaging system 122 (also referred to as an “imaging device”) configured to generate, provide, or send image data (also referred to as “images”) to another device or system. For example, the imaging system 122 can generate image data depicting an anatomy of the patient 110 and provide the image data to the control system 118, the robotic system 102, or another device. The imaging system 122 may include an emitter or energy source (such as an X-ray source) or a detector (such as an X-ray detector) mounted on a C-shaped arm support 124, which allows for flexibility in positioning around the patient 110 to capture images from various angles without moving the patient 110. Use of the imaging system 122 can provide visualization of internal structures or anatomy, which can be used for a variety of purposes, including navigation of the medical instrument 106 (such as by providing images of internal anatomy to a user) and localization of the medical instrument 106 (based on an analysis of image data), among other examples. In some aspects, the imaging system 122 may enhance the efficacy or safety of a medical procedure, such as a bronchoscopy, by providing clear, continuous visual feedback to the operating surgeon or team.

In some implementations, the imaging system 122 may be a mobile device configured to move around an environment. For example, the imaging system 122 can be positioned next to the patient 110 (as shown in FIG. 1) during a particular phase of a procedure and removed when the imaging system 122 is no longer needed. In some other implementations, the imaging system 122 may be part of the table 112 or other equipment in an operating environment. The imaging system 122 can be implemented as a Computed Tomography (CT) machine or system, X-ray machine or system, fluoroscopy machine or system, Positron Emission Tomography (PET) machine or system, PET-CT machine or system, CT angiography machine or system, Cone-Beam CT (CBCT) machine or system, three-dimensional rotational angiography (3DRA) machine or system, single-photon emission computed tomography (SPECT) machine or system, Magnetic Resonance Imaging (MRI) machine or system, Optical Coherence Tomography (OCT) machine or system, or ultrasound machine or system, among other examples. In some implementations, the medical system 100 may include different types of imaging systems that can be used or positioned over the patient 110 during different phases or portions of a procedure depending on the needs at that time.

In some implementations, the imaging system 122 may be configured to process multiple images (also referred to as “image data”) to generate a three-dimensional (3D) view or model. For example, the imaging device 122 can be implemented as a CT machine configured to capture or generate a series of images (also referred to as “tomograms) or image data representing two-dimensional (2D) cross-sections or slices of a 3D volume from different angles around the patient 110, and then use one or more algorithms to reconstruct these images or image data into a 3D model. The 3D model can be provided to the control system 118, robotic system 102, or another device, such as for processing or display.

In some implementations, image data from the imaging system 122 may be used to localize various elements, such as the medical instrument 106, a target within the anatomy, or specific anatomical features, among other examples. For example, the control system 118 can be configured to provide navigation information during a procedure to assist a user navigating the medical instrument 106 within the anatomy to reach a target (such as a desired treatment site or location). In some implementations, a target can include a nodule, such as in the context of certain bronchoscopy procedures. To illustrate, the control system 118 can display a navigation view or graphical data 126 that includes an instrument indicator 128 representing the medical instrument 106, a target indicator 130 representing the target, and an anatomical map. The navigation data 126(A) (such as initial navigation data) can be determined based on sensor data from a sensor of the medical instrument 106 (such as EM sensor data associated with the EM field generator 120), a map of the anatomy, or a location of the target. In some implementations, the map or location of the target may be determined based on preoperative data, such as data obtained during a preoperative procedure to find a target location or map the anatomy.

In some implementations, the navigation data 126(A) may be dynamically updated based on image data 132 from the imaging system 122. For example, the control system 118 can receive the image data 132 and analyze the image data 132 to determine a current or actual spatial relationship between the medical instrument 106 and the target. In some implementations, the control system 118 may display the image data 132 to a user, receive user input indicating a position of the medical instrument 106 or a position of the target in the image data 132, and analyze the image data 132 based on the user input to determine the current spatial relationship. If the control system 118 determines that the navigation data 126(A) incorrectly depicts the location of the medical instrument 106 (such as where the spatial relationship associated with the image data 132 is different than the spatial relationship associated with the navigation data 126(A)), the control system 118 may update the navigation data 126(A) at 134 and provide updated navigation data 126(B) that reflects the current or near real-time position of the medical instrument 106 relative to the target or the map.

The various components of the medical system 100 can be communicatively coupled to each other over a network, which can include a wireless or wired network. Example networks include one or more personal area networks (PANs), local area networks (LANs), wide area networks (WANs), Internet area networks (IANs), cellular networks, the Internet, personal area networks (PANs), body area network (BANs), etc. In some examples, various communication interfaces can include wireless technology, such as Bluetooth, Wi-Fi, near-field communication (NFC), or the like. Furthermore, in some examples, the various components of the medical system 100 can be connected for data communication, fluid exchange, power exchange, and so on, via one or more support cables, tubes, connections, or the like.

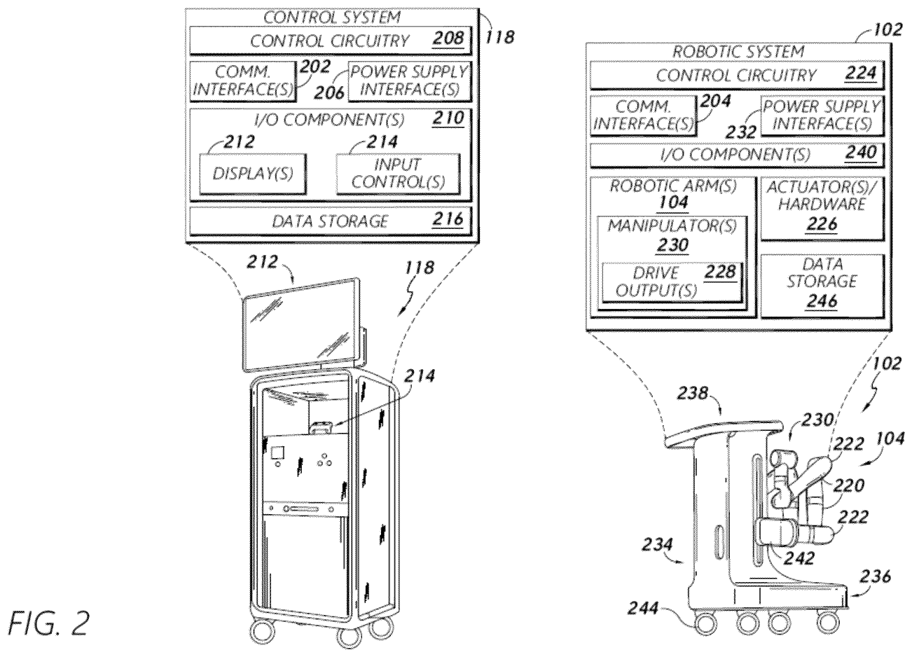

FIG. 2 shows example components of the control system 118 and the robotic system 102 of FIG. 1, according to some implementations. In the examples of FIG. 2, the control system 118 and the robotic system 102 are implemented as a tower and a robotic cart, respectively. However, the control system 118 and robotic system 102 can be implemented in other manners. The control system 118 can be coupled to the robotic system 102 and operate in cooperation therewith to perform a medical procedure. For example, the control system 118 can include communication interface(s) 202 for communicating with communication interface(s) 204 of the robotic system 102 via a wireless or wired connection (such as to control the robotic system 102). In some implementations, the control system 118 may communicate with the robotic system 102 to receive position or sensor data therefrom relating to the position of sensors associated with an instrument or member controlled by the robotic system 102. For example, the control system 118 may communicate with the EM field generator 120 to control generation of an EM field in an area around a patient. The control system 118 can further include one or more power supply interface(s) 206.

The control system 118 can include control circuitry 208 configured to cause one or more components of the medical system 100 to actuate or otherwise control any of the various system components, such as carriages, mounts, arms or positioners, medical instruments, imaging devices, position sensing devices, or sensors, among other examples. Further, the control circuitry 208 can be configured to perform other functions, such as cause display of information, process data, receive input, communicate with other components or devices, or any other function or operation described herein.

The control system 118 can further include one or more input or out (I/O) components 210 configured to assist a physician or others in performing a medical procedure. For example, the one or more I/O components 210 can be configured to receive input or provide output to enable a user to control or navigate the medical instrument 106, the robotic system 102, or other instruments or devices associated with the medical system 100. The control system 118 can include one or more displays 212 to provide, display or otherwise present various information regarding a procedure. For example, the one or more displays 212 can be used to present navigation information including a virtual anatomical model of anatomy with a virtual representation of a medical instrument, image data, or other information. The one or more I/O components 210 can include one or more user input control(s) 214, which can include any type of user input (or output) devices or device interfaces, such as one or more buttons, keys, joysticks, handheld controllers (such as video-game-type controllers), computer mice, trackpads, trackballs, control pads, sensors (such as motion sensors or cameras) that capture hand gestures and finger gestures, touchscreens, toggle (such as button) inputs, or interfaces or connectors therefore. In some implementations, such inputs can be used to generate commands for controlling one or more medical instruments, robotic arms, or other components.

The control system 118 can also include data storage 216 configured to store executable instruments (such as computer-readable instructions) that can be executed by the control circuitry 208 to cause the control circuitry 208 to perform various operations or functionality described herein. In some implementations, the data storage 216 also may store telemetry or runtime data (such as sensor data or image data) generated by the medical system 100 or otherwise captured or acquired during a medical procedure. In some implementations, two or more components of the control system 118 can be electrically or communicatively coupled to each other.

The robotic system 102 can include the one or more robotic arms 104 configured to engage with or control, for example, the medical instrument 106 or other elements or components to perform one or more aspects of a procedure. As shown in FIG. 2, each robotic arm 104 can include multiple segments 220 coupled to joints 222, which can provide multiple degrees of movement or freedom. The robotic system 102 can be configured to receive control signals from the control system 118 to perform certain operations, such as to position one or more of the robotic arms 104 in a particular manner or manipulate an instrument, among other examples. In response, the robotic system 102 can control, using control circuitry 224 thereof, actuators 226 or other components of the robotic system 102 to perform the operations. For example, the control circuitry 224 can control insertion or retraction, articulation, or roll of a shaft of the medical instrument 106 or other instrument by actuating one or more drive outputs 228 of a manipulator 230 (or end-effector) coupled to a base of a robotically-controllable instrument. The drive outputs 228 can be coupled to a drive input on an associated instrument, such as an instrument base of an instrument that is coupled to the associated robotic arm 104. The robotic system 102 also may include one or more power supply interfaces 232.

The robotic system 102 can include a support column 234, a base 236, or a console 238. The console 238 can provide one or more I/O components 240, such as a user interface for receiving user input or a display screen (or a dual-purpose device, such as a touchscreen) to provide the physician or user with preoperative or intraoperative data. The support column 234 can include an arm support 242 (also referred to as a “carriage”) for supporting the deployment of the one or more robotic arms 104. The arm support 242 can be configured to vertically translate along the support column 234. Vertical translation of the arm support 242 allows the robotic system 102 to adjust the reach of the robotic arms 104 to meet a variety of table heights, patient sizes, or physician preferences. The base 236 can include wheel-shaped casters 244 (also referred to as “wheels”) that allow the robotic system 102 to move around the operating room. After reaching the appropriate position, the casters 244 can be immobilized using wheel locks to hold the robotic system 102 in place during the procedure.

The joints 222 of each robotic arm 104 can each be independently-controllable or provide an independent degree of freedom available for instrument navigation. In some implementations, each robotic arm 104 may include seven joints that provide seven degrees of freedom, including “redundant” degrees of freedom. Redundant degrees of freedom can allow robotic arms 104 to be controlled to position their respective manipulators 230 at a specific position, orientation, or trajectory in space using different linkage positions and joint angles. This allows for the robotic system 102 to position or direct a medical instrument from a desired point in space while allowing the physician to move the joints 222 into a clinically advantageous position away from the patient to create greater access, while avoiding collisions.

The one or more manipulators 230 (or end-effectors) can be coupled to an instrument base or handle, which can be attached using a sterile adapter component. The combination of the manipulator 230 and instrument base, as well as any intervening mechanics or couplings (such as the sterile adapter), can be collectively referred to as the manipulator or a manipulator assembly. Manipulators or manipulator assemblies can provide power or control interfaces. Example interfaces may include connectors to transfer pneumatic pressure, electrical power, electrical signals, or optical signals from the robotic arm 104 to an instrument base. Manipulators or manipulator assemblies can be configured to manipulate medical instruments (such as surgical tools) using techniques including, for example, direct drives, harmonic drives, geared drives, belts or pulleys, or magnetic drives, among other examples.

The robotic system 102 can also include data storage 246 configured to store executable instruments (such as computer-readable instructions) that can be executed by the control circuitry 224 to cause the control circuitry 224 to perform various operations or functionality described herein. In some implementations, the data storage 216 also may store telemetry or runtime data (such as sensor data or image data) generated by the medical system 100 or otherwise captured or acquired during a medical procedure. In some implementations, two or more of the components of the robotic system 102 can be electrically or communicatively coupled to each other.

Data storage (including the data storage 216, data storage 246, or other data storage or memory) can include any suitable or desirable type of computer-readable media. For example, computer-readable media can include one or more volatile data storage devices, non-volatile data storage devices, removable data storage devices, or nonremovable data storage devices implemented using any technology, layout, or data structure(s) or protocol, including any suitable or desirable computer-readable instructions, data structures, program modules, or other types of data.

Computer-readable media that can include, but is not limited to, phase change memory, static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device. As used in certain contexts herein, computer-readable media may not generally include communication media, such as modulated data signals and carrier waves. As such, computer-readable media should generally be understood to refer to non-transitory media.

Functionality described herein can be implemented by the control circuitry 208 of the control system 118 or the control circuitry 224 of the robotic system 102, such as by the control circuitry 208 or 224 executing instructions to cause the control circuitry 208 or 224 to perform the functionality. Control circuitry (including the control circuitry 208, control circuitry 224, or other control circuitry) can include circuitry embodied in a robotic system, control system or tower, instrument, or any other component or device. Control circuitry can include any collection of processors, processing circuitry, processing modules or units, chips, dies (such as semiconductor dies including one or more active or passive devices or connectivity circuitry), microprocessors, micro-controllers, digital signal processors, microcomputers, central processing units, field-programmable gate arrays, programmable logic devices, state machines (such as hardware state machines), logic circuitry, analog circuitry, digital circuitry, or any device that manipulates signals (analog or digital) based on hard coding of the circuitry or operational instructions.

Control circuitry referenced herein can further include one or more circuit substrates (such as printed circuit boards), conductive traces and vias, or mounting pads, connectors, or components. Control circuitry can further include one or more storage devices, which may be embodied in a single device, a plurality of devices, or embedded circuitry of a device. Such data storage can comprise read-only memory, random access memory, volatile memory, non-volatile memory, static memory, dynamic memory, flash memory, cache memory, data storage registers, or any device that stores digital information. In examples in which control circuitry includes a hardware or software state machine, analog circuitry, digital circuitry, or logic circuitry, data storage device(s) or register(s) storing any associated operational instructions can be embedded within, or external to, the circuitry comprising the state machine, analog circuitry, digital circuitry, or logic circuitry.

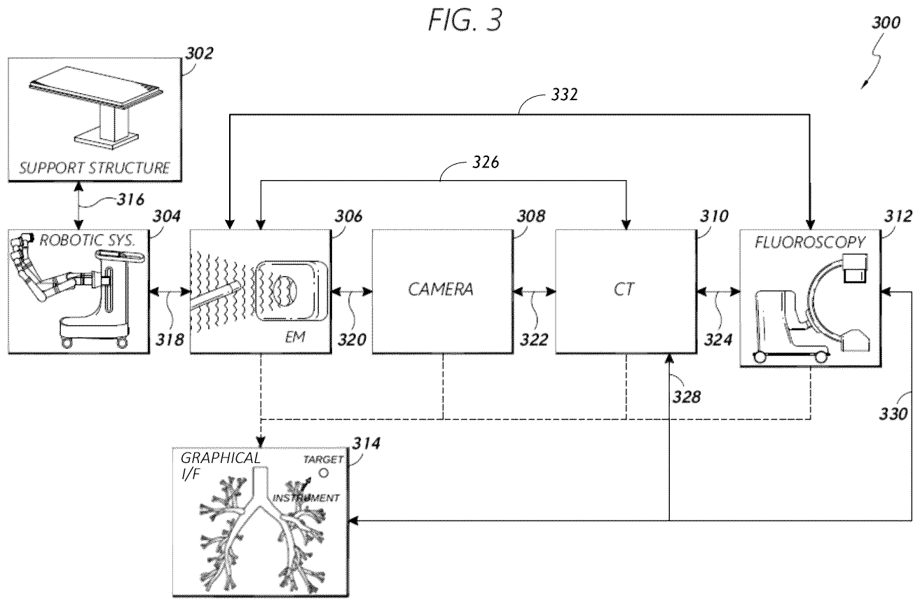

FIG. 3 shows a block diagram of an example localization system 300, according to some implementations. The localization system 300 includes various positioning or imaging systems or modalities 302-312 (also referred to as “subsystems”), which can be implemented to facilitate anatomical mapping, navigation, positioning, or visualization for procedures in accordance with one or more examples. For example, the various systems 302-312 can be configured to provide data for generating an anatomical map, determining a location of an instrument, determining a location of a target, or performing other techniques.

Each of the systems 302-312 can be associated with a respective coordinate space (also referred to as a “position coordinate frame”) or can provide data or information relating to instrument or anatomy locations, wherein registering the various coordinate spaces to one another can allow for integration of the various systems to provide mapping, navigation, or instrument visualization. For example, registering a first modality to a second modality can allow for determined positions in the first modality to be tracked or superimposed on or in a reference frame associated with the second modality, thereby providing layers of positional information that can be combined to provide a robust localization system.

In some implementations, the system 300 may be configured to implement one or more localization or localizing techniques. As used herein, the terms “localization” or “localizing” refer to any processes for determining an instrument position (or location) and orientation (or heading), collectively referred to as the “pose” of the instrument or other element or component, within a given space or environment.

In some implementations, the anatomical space in which a medical instrument can be localized (such as where a position or shape of the instrument is determined or estimated) may be a 2D or 3D portion of a patient's tracheobronchial airways, vasculature, urinary tract, gastrointestinal tract, or any organ or space accessed via lumens. Various modalities can be implemented to provide images, representations, or models of the anatomical space. For example, an imaging modality can be implemented, which can include, for example, X-ray, fluoroscopy, CT, PET, PET-CT, CT angiography, CBCT, 3DRA, SPECT, MRI, OCT, or ultrasound, among other examples. In some implementations, the imaging modality may be used to capture or acquire images of a patient's anatomy during a preoperative phase of a medical procedure. In some other implementations, the imaging modality may be used to capture or acquire images of a patient's anatomy during an intraoperative phase of the medical procedure.

The systems 302-312 can provide information for generating a graphical user interface 314 (also referred to as a “graphical interface (I/F)”) that includes navigation information for navigating an instrument to a target within an anatomy (such as the navigation data 126(A) or 126(B) of FIG. 1). For example, the navigation information may include an anatomical map, an estimated position, orientation, or shape of the instrument, and/or a position, shape, eccentricity, border, size, or texture of the target. In some implementations, the graphical user interface 314 or other localization information may be displayed to a user, such as a physician, during a medical procedure to assist the user in performing the procedure. For example, a visualization of a tracked instrument can be superimposed on an anatomical map depicted by the graphical user interface 314 based on position or sensor data associated with the tracked medical instrument.

As shown in FIG. 3, the system 300 can include a support structure 302 (such as a surgical bed or other patient positioning or support platform). For example, the support structure 302 includes a planar surface that contacts and supports the patient. In some implementations, the position of the support structure 302 may be known based on data maintained relating to the position of the support structure 302 within the surgical or procedure environment. In some other implementations, the position of the support structure 302 may be sensed or otherwise determined using one or more markers or an appropriate imaging or positioning modality.

The system 300 can further include a robotic system 304 (such as a robotic cart or other device or system including one or more robotic end effectors). In some implementations, the robotic system 304 may be one example of the robotic system 102 of FIGS. 1 and 2. Data relating to the position or state of robotic arms, actuators, or other components of the robotic system 304 can be known or derived from robotic command data or other robotic data relative to a coordinate frame of the robotic system 304. In some examples, reference frame registration 316 occurs between the support structure 302 and the robotic system 304, which can be a relatively coarse registration, in some implementations, based on robotic system or cart-set-up procedure (which can have any suitable or desirable scheme).

The system 300 can further include an electromagnetic (EM) sensor system 306, which can include an EM field generator (such as the EM field generator 120 of FIG. 1) and one or more EM sensors. An EM sensor can be associated with a portion of an instrument that is tracked or controlled, such as a distal end (or tip) of the instrument or along a length of the instrument or other elongate member (such as a working channel) disposed in a lumen of the instrument. In some implementations, the EM field generator can be mechanically coupled to the support structure 302 or the robotic system 304 such that registration or association 318 between such systems can be known or determined. In some implementations, the registration 318 between the EM sensor system 306 and the robotic system 304 can be determined through forward kinematics or field generator mount transform information. For example, the field generator can be mounted to the support structure 302 such that the position of the field generator can be known relative to the robotic system positioning frame based on a known relationship between the position of the support structure 302 and the robotic system 304. The EM sensor system 306 can provide instrument pose or path information based on sensor readings associated with the instrument.

The system 300 can further include an optical camera system 308 including one or more cameras or other imaging devices configured to generate images of patient anatomy within a visual field thereof (such as real-time image data) during a surgical procedure. In some implementations, registration 320 between the optical camera system 308 and the EM sensor system 306 can be achieved through identification of features having EM sensor data associated therewith, such as a medical instrument tip, in images generated by the optical camera system 308. The registration 320 can further be based at least in part on hand-eye interaction of the physician when viewing real-time camera images while the EM-sensor-equipped endoscope is navigating in the patient anatomy.

The system 300 can further include a computed tomography (CT) imaging system 310 configured to generate CT images of the patient anatomy, which can be performed preoperatively or intraoperatively. The CT imaging system 310 is generally used for scanning a relatively large volume. In some implementations, image processing can be implemented for registration 322 of the CT image data with the camera image data generated by the optical camera system 308. For example, common features identified in both camera image data and CT image data can be identified to relate the CT image frame to the camera image frame in space. In some examples, the CT imaging system 310 can be used to generate preoperative imaging data for producing the graphical user interface 314 or for path navigation planning.

In some aspects, the CT imaging system 310 may be registered 326 to the EM sensor system 306 through various techniques, such as tool registration or a transformation function, among other examples. In some implementations, a mechanical structure of the CT imaging system 310 can have a known physical transform or relationship with respect to a mounting position of the EM field generator of the EM sensor system 306. Such known relationship can be used to register the CT image space to the EM sensor space. The connection 328 represents a mapping or relationship between the CT imaging system 310 and an anatomical map depicted by a graphical user interface 314.

The system 300 can further include a fluoroscopy imaging system 312 configured to generate tomographic images (such as real-time X-ray images) of the surgical site. The fluoroscopy imaging system 312 is generally used for scanning a smaller volume compared to the CT imaging system 310. In some implementations, the fluoroscopy imaging system 312 may be one example of the imaging system 122 of FIG. 1. For example, the fluoroscopy imaging system 312 may include a CBCT scanner coupled to a C-arm. In some implementations, the fluoroscopy imaging system 312 may be used with a contrast agent introduced into the anatomy to generate image data representing patient anatomy or instrumentation. In some aspects, the fluoroscopy imaging system 312 may be registered 324 to the CT imaging system 310 based on 3D images of an anatomy captured by the imaging system 310 and 312. Example suitable image-based registration techniques include image processing (such as segmentation or computer vision), statistical measures of similarity, and machine learning, among other examples.

In some aspects, the fluoroscopy imaging system 312 may be registered 332 to the EM sensor system 306 through various techniques, such as tool registration or a transformation function, among other examples. In some implementations, a mechanical structure of the fluoroscopy imaging system 312 (such as the C-arm instrumentation) can have a known physical transform or relationship with respect to a mounting position of the EM field generator of the EM sensor system 306. Such known relationship can be used to register the fluoroscopy image space to the EM sensor space. The connection 330 represents a mapping or relationship between the fluoroscopy imaging system 312 and an anatomical map depicted by the graphical user interface 314.

In the example of FIG. 3, the CT imaging system 310 and fluoroscopy imaging system 312 are illustrated as separated systems. However, in some other implementations, a single imaging system may perform the functions of both the CT imaging system 310 and fluoroscopy imaging system 312. Although the systems 302-312 have been described in a particular order, the operations or functions associated therewith can be performed in different orders. In some implementations, the systems 302-312 can be used in different ways. In some other implementations, registration can occur between different systems and modalities.

The position, shape, or orientation of an instrument, such as an endoscope, can be determined using any one or more of the systems 302-312, which can facilitate generation of graphical interface data representing the estimated position or shape of the instrument relative to an anatomical model depicted by the graphical user interface 314. For example, the graphical user interface 314 can be displayed on a display device, such as via the control system 118 or robotic system 102, or another device. In some implementations, the graphical user interface 314 also may indicate a position of a target within the anatomy that has been designated for treatment and/or a planned path for the instrument to follow to reach or otherwise access the target within the anatomy (also referred to as a “navigation path”).

In some aspects, the localization system 300 (or a controller associated therewith) may generate the anatomical model depicted in the graphical interface 314 based on image data captured during a preoperative phase of a medical procedure (such as via the CT imaging system 310). For example, the image data may be analyzed using image processing techniques to determine cavities or anatomical spaces within the anatomy, such as branches of a lung or calyxes of a kidney, through which an instrument (such as a scope or catheter) can be navigated. Example suitable image processing techniques include segmentation, machine learning, and statistical analysis, among other examples. As used herein, the term “segmentation” refers to various techniques for partitioning a digital image into groups of voxels (or “image segments”) based on related characteristics or identifying features. In some implementations, the anatomical spaces may be expressed as lumens with centerline coordinates (representing the center of the lumen) in 3D space. The volume of such cavities may be determined by measuring a diameter of the lumen at each centerline coordinate. The localization system 300 may use the centerline coordinates and corresponding diameter distances to generate a 3D model of the anatomy on which the instrument pose may be projected or superimposed to provide navigational guidance.

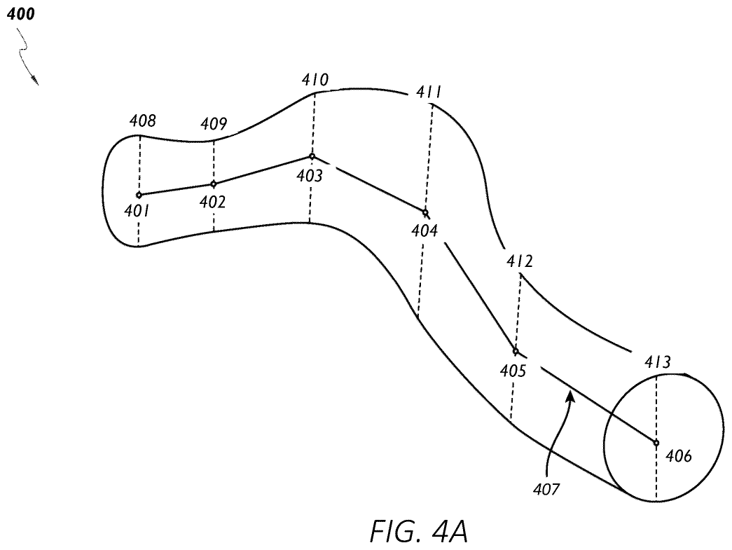

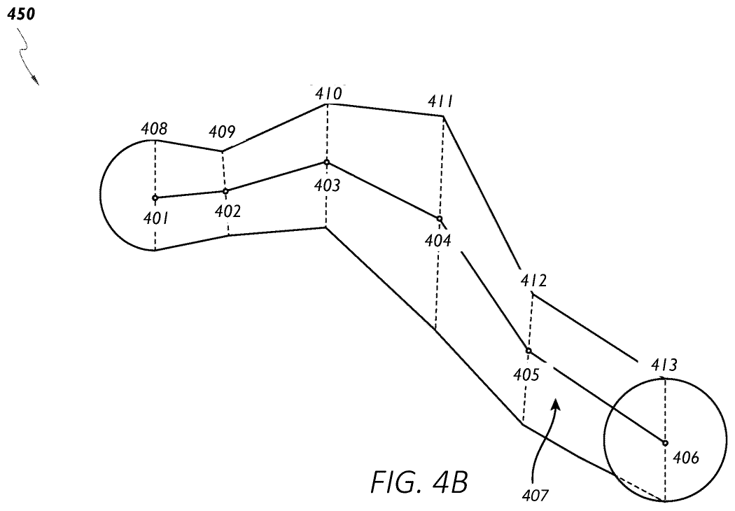

FIG. 4A shows an example anatomical lumen 400 that can be scanned using 3D imaging technologies (such as the CT imaging system 310 and/or the fluoroscopy imaging system 312 of FIG. 3). Aspects of the present disclosure recognize that the anatomical lumen 400 may be tracked longitudinally by centerline coordinates 401-406, where each centerline coordinate approximates the center of the lumen 400. As shown in FIG. 4A, the centerline coordinates 401-406 may be connected to establish a centerline model 407 for visualizing a general shape of the anatomical lumen 400. The volume of the lumen 400 may be further visualized by measuring or estimating the diameter or diameter of the lumen 400 at each of the centerline coordinates 401-406. In the example of FIG. 4A, dotted lines 408-413 depict the widths of the lumen 400 measured at the centerline coordinates 401-406, respectively. As shown in FIG. 4A, each of the dotted lines 408-413 may represent the diameter (or radius) of a respective two-dimensional (2D) circle centered around a respective centerline coordinate.

FIG. 4B shows an example anatomical model 450 that can be reconstructed from 3D images of the anatomical lumen 400 of FIG. 4A, according to some implementations. In some implementations, the anatomical model 450 may be one example of the anatomical model shown in the graphical interface 314 of FIG. 3. More specifically, the anatomical model 450 may be a rendering or recreation of the anatomical lumen 400 (in 3D space) based on the centerline coordinates 401-406 and/or the centerline model 407. The volume of the lumen 400 can be extrapolated from the measurements 408-413 associated with the centerline coordinates 401-406, respectively. For example, the edges or boundaries of the anatomical model 450 (representing the walls of the lumen 400) may be reconstructed by connecting the edges of the 2D circles in 3D space. More accurate approximations may be determined by increasing the resolution of the centerline coordinates 401-406 and/or measurements 408-413 (such as by increasing the density of the coordinates or measurements for a given lumen or subsection).

In some aspects, the graphical interface 314 of FIG. 3 may further include an optimal or “recommended” navigation path, for navigating the instrument to a target within the anatomy, associated with the anatomical model. For example, the localization system 300 (or a controller associated therewith) may determine the position of the target within the anatomy by analyzing the image data using one or more image processing techniques and may map the target position to the anatomical model. The system 300 may further calculate a shortest path through the anatomical model for navigating the instrument to the target. In some implementations, the navigation path may trace or closely adhere to at least a portion of a centerline model. For example, the system 300 may map the position of the target to the nearest centerline coordinate in the anatomical model so that the navigation path traces a segment of the centerline model that terminates at the centerline coordinate associated with the target.

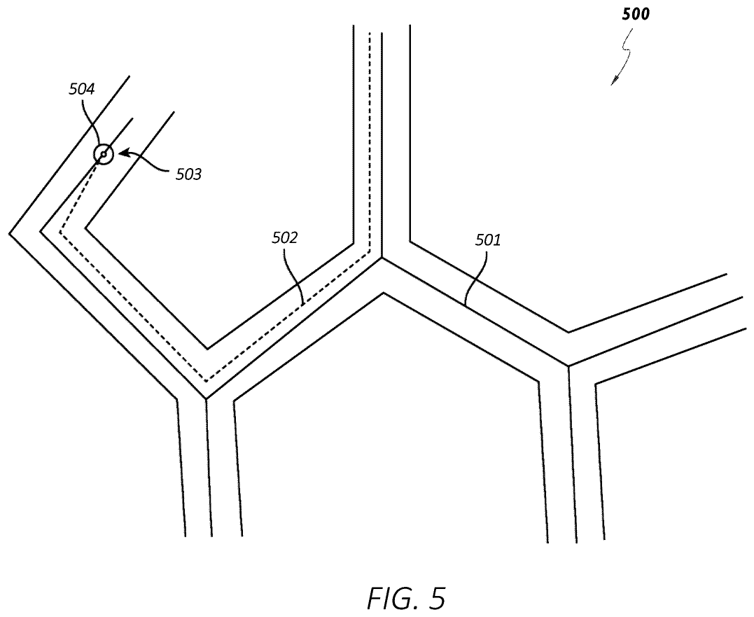

FIG. 5 shows an example graphical interface 500 for navigating an instrument to a target within an anatomy, according to some implementations. In some implementations, the graphical interface 500 may be one example of the graphical interface 314 of FIG. 3. More specifically, the graphical interface 500 depicts an anatomical model (such as a luminal network) having a centerline 501 and a target location 503 (also referred to as an “operative site”) mapped to a nearest centerline coordinate 504. With reference to FIGS. 4A and 4B, the centerline 501 may be one example of the centerline model 407 and the centerline coordinate 504 may be one example of any of the centerline coordinates 401-406. The graphical interface 500 also depicts a navigation path 502 through a portion of the anatomy. The navigation path 502 represents a recommended or optimal path for driving an endoluminal instrument (such as a scope or a catheter) to the target location 503. As shown in FIG. 5, the navigation path 502 traces or overlaps with a portion of the centerline 501 that terminates at the centerline coordinate 504.

With reference for example to FIG. 3, one or more of the systems 302-312 may be used to generate the graphical interface 500 preoperatively or determine the target location 503 during a preoperative phase of a medical procedure. However, a graphical user interface generated based on preoperative image data may not accurately reflect the spatial relationship between the instrument and the target during an intraoperative phase. For example, changes in the patient's anatomy or the medical environment can cause the spatial relationship between the instrument and the target to deviate from what is depicted in the graphical user interface 500. Example factors that may cause such deviations include EM distortion, poor registration (or mapping) between the sensor data and the image data, outdated preoperative image data, and anatomical deformations, among other examples. Thus, in some aspects, one or more of the systems 302-312 may be used to determine a location of a medical instrument or position of a target relative to an anatomical model during an intraoperative phase of a medical procedure.

As described with reference to FIG. 3, the localization system 300 may track the instrument pose via the EM sensor system 306. However, image data and sensor data may be associated with different coordinate spaces. For example, the image data may describe data points (such as coordinates or vectors) in relation to a coordinate space defined by an imaging system (such as the fluoroscopy imaging system 312) whereas the sensor data may describe data points (such as coordinates or vectors) in relation to a coordinate space defined by a sensing system (such as the EM sensor system 306). To combine the sensor data and the image data on a single frame of reference (such as the graphical interface 314), the system 300 may register the coordinate space associated with the image data (also referred to as the “image space”) with the coordinate space associated with the sensor data (also referred to as the “sensor space”). As used herein, the term “registration” refers to a mapping between different coordinate spaces.

Aspects of the present disclosure recognize that the EM sensor system 306 may be registered 326 with the CT imaging system 310 during a preoperative phase of the medical procedure (such as to generate the graphical interface 500 of FIG. 5). In other words, the EM sensor data may already be registered or mapped to the preoperative image space. Thus, in some other aspects, the system 300 may register 324 the fluoroscopy imaging system 312 with the CT imaging system 310, using image-based registration techniques, and leverage the EM-to-CT registration 326 to map the sensor data and the image data to a common coordinate frame (such as the CT image space). More specifically, the system 300 may further use the fluoroscopy-to-CT registration 324 and the EM-to-CT registration 326 to dynamically update the graphical user interface 314 to reflect the current or actual spatial relationship between the instrument and the target during the intraoperative phase, as depicted by the image data captured via the fluoroscopy imaging system 312 (such as to facilitate real-time navigation).

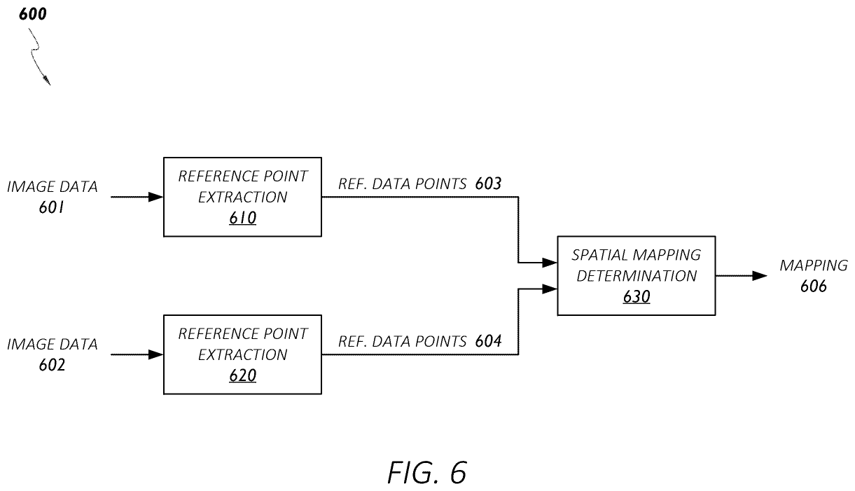

FIG. 6 shows a block diagram of an example registration system 600, according to some implementations. In some implementations, the registration system 600 may be one example of any of the control circuitry 208 or 224 of FIG. 2. More specifically, the registration system 600 may be configured to register a first imaging system used for capturing images preoperatively (such as the CT imaging system 310 of FIG. 3) with a second imaging system used for capturing images of the anatomy intraoperatively (such as the fluoroscopy imaging system 312 of FIG. 3).

The registration system 600 is configured to determine a mapping 606 between a coordinate space associated with the first imaging system (also referred to as the “preoperative image space”) and a coordinate space associated with the second imaging system (also referred to as the “intraoperative image space”) based, at least in part, on image data 601 and 602 captured via the first and second imaging systems, respectively. For example, the mapping 606 may be used to transform any data point in the intraoperative image space to a respective data point in the preoperative image space, or vice-versa. In some implementations, the image data 601 may include one or more tomograms depicting a 3D image of an anatomy captured by a CT imaging system (such as described with reference to FIGS. 1-3) and the image data 602 may include one or more tomograms depicting a 3D image of the anatomy captured by a fluoroscopy imaging system (such as described with reference to FIGS. 1-3).

In some aspects, the registration system 600 may determine the mapping 606 using point-based registration techniques. In other words, the registration system 600 analyzes the image data 601 and 602 to identify matching data points between the preoperative image space and the intraoperative image space. For example, the matching data points may coincide with the same objects and/or features depicted in the images captured by both the first and second imaging systems. After identifying pairs of matching data points between the image spaces, the registration system 600 may determine the mapping 606 that maps or otherwise transforms each of the matching data points in one image space (such as the intraoperative image space) to a respective one of the matching data points in the other image space (such as the preoperative image space).

The registration system 600 includes a first reference point extraction component 610, a second reference point extraction component 620, and a spatial mapping determination component 630. The first reference point extraction component 610 is configured to determine one or more reference data points 603 in the preoperative image space based on the image data 601, and the second reference point extraction component 620 is configured to determine one or more reference data points 604 in the intraoperative image space based on the image data 602. As used herein, the term “reference data point” may refer to any object, feature, point, or vector that can be identified or detected in both the preoperative image space and the intraoperative image space. In some aspects, the reference data points 603 and 604 may include positions and/or orientations of various features (such as anatomical features and/or features associated with an instrument) that can be extracted and/or interpolated from the image data 601 and 602. In some implementations, the reference data points 603 and 604 may include a position and/or geometry (or morphology) of one or more target nodules that can be found, using any suitable image processing technique, in both the image data 601 and the image data 602.

In some implementations, the reference data points 603 and 604 may include various centerline coordinates associated with the anatomy that can be found in both the preoperative image space and the intraoperative image space (such as the centerline coordinates 401-406 of FIGS. 4A and 4B or the centerline 501 of FIG. 5). For example, the reference point extraction component 610 may perform an image processing operation (such as segmentation) that labels or classifies each voxel of the image data 601 as belonging to the anatomy or not belonging to the anatomy and may interpolate the centerline coordinates (as the reference data points 603) from the voxels labeled as belonging to the anatomy. Similarly, the reference point extraction component 620 may perform the same (or similar) image processing operation to label or classify each voxel of the image data 602 as belonging to the anatomy or not belonging to the anatomy and may further interpolate the centerline coordinates (as the reference data points 604) from the voxels labeled as belonging to the anatomy.

In some other implementations, the reference data points 603 may include various points along a navigation path associated with the anatomy (such as the navigation path 502 of FIG. 5) and the reference data points 604 may include various points along an instrument disposed within the anatomy. For example, the reference point extraction component 610 may perform an image processing operation that labels or classifies each voxel of the image data 601 as belonging to the anatomy or not belonging to the anatomy and may interpolate the centerline coordinates from the voxels labeled as belonging to the anatomy. The reference point extraction component 610 also may perform an image processing operation that detects and/or segments a target for treatment (such as a nodule) from the image data 601. The reference point extraction component 610 may further determine a navigation path (as the reference data points 603) from an endoluminal seed (such as the highest point in the luminal network) to the centerline coordinate nearest the target (such as described with reference to FIG. 5).

Aspects of the present disclosure recognize that, as the instrument is driven along the navigation path, the shape and/or curvature of the instrument tracks or follows the shape and/or curvature of the navigation path. As a result, various points on the instrument (such as along its centerline) may overlap or coincide with respective points along the navigation path (such as along the centerline of the anatomy). Thus, the reference point extraction component 620 may perform an image processing operation (such as segmentation or image thresholding) that labels or classifies each voxel of the image data 602 as belonging to the instrument or not belonging to the instrument and may interpolate various points along the centerline of the instrument (as the reference data points 604) from the voxels labeled as belonging to the instrument. Aspects of the present disclosure further recognize that medical instruments are often much denser, and thus appear brighter on fluoroscopic images and CT scans, than the surrounding anatomy. Thus, in some implementations, the reference point extraction component 620 may detect the voxels associated with the instrument using one or more image processing techniques (such as thresholding, spline detection, or machine learning, among other examples).

The spatial mapping determination component 630 is configured to determine the mapping 606 based, at least in part, on the reference data points 603 in the preoperative image space and the reference data points 604 in the intraoperative image space. For example, the mapping 406 may be a transformation matrix. Aspects of the present disclosure recognize that at least 3 unique reference data points (which may include any combination of coordinates or vectors) are needed to define a unique transformation matrix in 3D space. For example, given 3 unique reference data points 603 in the preoperative image space and 3 corresponding reference data points 604 in the intraoperative image space, the spatial mapping determination component 630 can determine a transformation matrix that transforms the reference data points 604 into the reference data points 603 (or vice-versa) using various known techniques or algorithms. Example suitable algorithms include singular value decomposition (SVD) and the iterative closest point algorithm (ICP), among other examples.

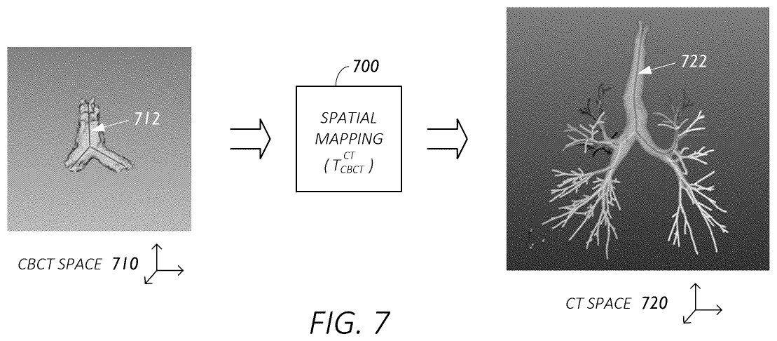

FIG. 7 shows an example mapping 700 between a CBCT image space 710 and a CT image space 720, according to some implementations. For example, the CBCT image space 710 may represent an intraoperative image space and the CT image space 720 may represent a preoperative image space. In some implementations, the spatial mapping 700 may be determined by the registration system 600 of FIG. 6. More specifically, with reference to FIG. 6, the spatial mapping 700 may be one example of the mapping 606.

The CBCT image space 710 is shown to include a centerline model 712 depicting the centerline coordinates for at least a portion of an anatomy. With reference for example to FIG. 6, the centerline model 712 may be extracted by the reference point extraction component 620 based on image data captured by a CBCT imaging system (such as the fluoroscopy imaging system 312 of FIG. 3). The CT image space 720 is shown to also include a centerline model 722 depicting the centerline coordinates for a larger portion of the anatomy. With reference for example to FIG. 6, the centerline model 722 may be extracted by the reference point extraction component 610 based on image data captured by a CT imaging system (such as the CT imaging system 310 of FIG. 3).

As shown in FIG. 7, the centerline model 712 is substantially similar (if not identical) to the centerline model 722 for at least the portion of the anatomy that is captured in both the CBCT image space 710 and the CT image space 720. Moreover, each of the centerline models 712 and 722 represents a respective set of ordered points. Thus, the spatial mapping 700 may be a transformation matrix

$$( {T}_{C B C T}^{C T} )$$

that transforms the set of ordered points along the centerline model 712 into a respective subset of ordered points along the centerline model 722. With reference for example to FIG. 6, the spatial mapping determination component 630 may select pairs of points from the centerline models 712 and 722 and compute the transformation

$${T}_{C B C T}^{C T}$$

that transforms the selected data points (X) on the centerline model 712 into the set of data points (Y) on the centerline model 722, or minimizes the distance between the points, where:

$$Y = {T}_{CBCT}^{CT} X$$

The transformation matrix

$${T}_{C B C T}^{C T}$$

includes a rotation matrix R_{reg} and a translation vector t_{reg}, where

$${T}_{C B C T}^{C T} = ( \begin{matrix}{R}_{r e g} & {t}_{r e g}\end{matrix} ) .$$

In some implementations, the spatial mapping determination component 630 may solve for the rotation matrix R_{reg} using singular value decomposition (SVD). For example, the spatial mapping determination component 630 may determine an orthogonal matrix U, a diagonal matrix S, and an orthogonal matrix V, where:

$$S V D ( C {E}^{T} ) = U S {V}^{T}$$

$${R}_{r e g} = V {U}^{T}$$

The spatial mapping determination component 630 may further calculate the translation vector t_{reg} based on the pairs of point coordinates X and Y, where:

$${t}_{r e g} = Y - {R}_{r e g} X$$

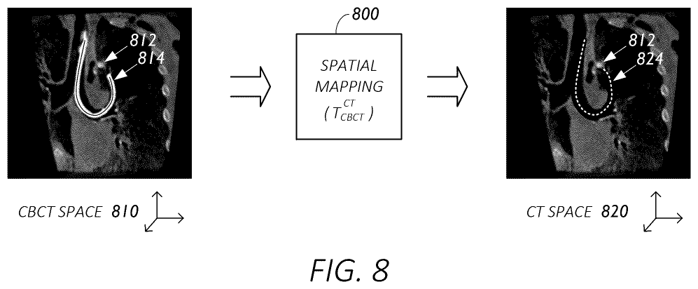

FIG. 8 shows another example mapping 800 between a CT image space 810 and a CBCT image space 820, according to some implementations. For example, the CBCT image space 810 may represent an intraoperative image space and the CT image space 820 may represent a preoperative image space. In some implementations, the spatial mapping 800 may be determined by the registration system 600 of FIG. 6. More specifically, with reference to FIG. 6, the spatial mapping 800 may be one example of the mapping 606.

The CBCT image space 810 is shown to include a centerline 814 (shown in black) of an instrument (shown in white) within an anatomy. With reference for example to FIG. 6, the centerline 814 may be extracted by the reference point extraction component 620 based on image data captured by a CBCT imaging system (such as the fluoroscopy imaging system 312 of FIG. 3). The CT image space 820 is shown to include a navigation path 824 depicting an optimal or recommended path for an instrument to follow to reach a target 812 within the anatomy. With reference for example to FIG. 6, the navigation path 824 may be extracted by the reference point extraction component 610 based on image data captured by a CT imaging system (such as the CT imaging system 310 of FIG. 3).

As shown in FIG. 8, the instrument centerline 814 is substantially similar (if not identical) to the navigation path 824 for at least the portion of the anatomy that is captured in both the CBCT image space 810 and the CT image space 820. Moreover, the instrument centerline 814 and the navigation path 824 each represents a respective set of ordered points. Thus, the spatial mapping 800 may be a transformation matrix

$$( {T}_{C B C T}^{C T} )$$

that transforms the set of ordered points along the instrument centerline 814 into a respective subset of ordered points along the navigation path 824. With reference for example to FIG. 6, the spatial mapping determination component 630 may select pairs of points from the instrument centerline 814 and the navigation path 824 and compute the transformation

$${T}_{C B C T}^{C T}$$

that transforms the selected data points (X) on the instrument centerline 814 into the set of data points (Y) on the navigation path 824, or minimizes the distance between the points (such as described with reference to FIG. 7).

Aspects of the present disclosure recognize that the instrument centerline 814 more closely matches the navigation path 824 at the endoluminal seed (such as the trachea the lungs) and tends to diverge closer to the target 812 (such as due to CT-to-body divergence and/or a user's inability to advance the instrument in a manner that closely follows or overlaps the navigation path 824). Thus, to minimize error in the spatial mapping 800, each set of data points X and Y may be selected to include points along the instrument centerline 814 and the navigation path 824 closer to the seed (such as in the trachea and the main bronchi) and to exclude points along the instrument centerline 814 and the navigation path 824 closer to the target (such as in the terminal airways or other peripheral airways closer to the target). In some implementations, the spatial mapping 800 may be further refined using voxel-based registration (such as to ensure that individual voxels of the original CBCT image map to corresponding voxels of the CT image).

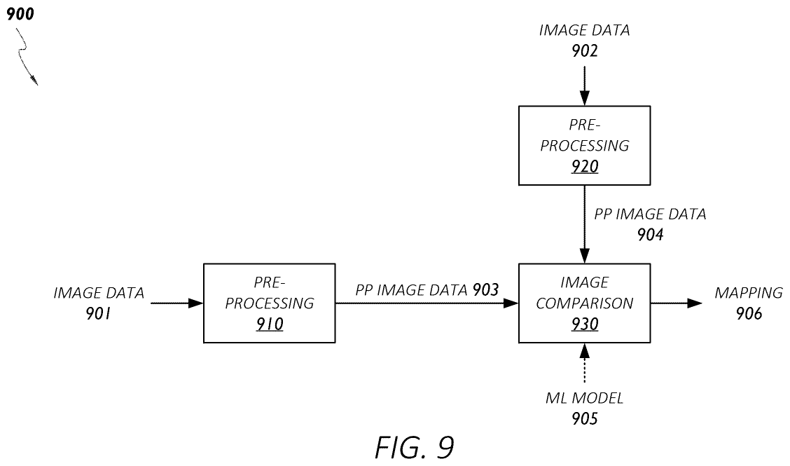

FIG. 9 shows another block diagram of an example registration system 900, according to some implementations. In some implementations, the registration system 900 may be one example of any of the control circuitry 208 or 224 of FIG. 2. More specifically, the registration system 900 may be configured to register a first imaging system used for capturing images preoperatively (such as the CT imaging system 310 of FIG. 3) with a second imaging system used for capturing images of the anatomy intraoperatively (such as the fluoroscopy imaging system 312 of FIG. 3).

The registration system 900 is configured to determine a mapping 906 between the preoperative image space and the intraoperative image space based, at least in part, on image data 901 and 902 captured via the first and second imaging systems, respectively. For example, the mapping 906 may be used to transform any data point in the intraoperative image space to a respective data point in the preoperative image space, or vice-versa. In some implementations, the image data 901 may include one or more tomograms depicting a 3D image of an anatomy captured by a CT imaging system (such as described with reference to FIGS. 1-3) and the image data 902 may include one or more tomograms depicting a 3D image of the anatomy captured by a fluoroscopy imaging system (such as described with reference to FIGS. 1-3).

In some aspects, the registration system 900 may determine the mapping 906 using alignment-based registration techniques. In other words, the registration system 900 compares the image data 901 with the image data 902 to determine how the image in the preoperative image space differs from the image in the intraoperative image space. The registration system 900 may then determine the mapping 906 that reduces or minimizes the differences between the images (or otherwise optimizes a similarity metric between the images). Aspects of the present disclosure recognize that the images associated with the preoperative image space may have a different field of view (FOV) and/or voxel intensities than the images associated with the intraoperative image space. Thus, in some implementations, the registration system 900 may adjust or modify the image data 901 and 902 to reduce or eliminate the impacts of FOV and/or voxel intensities on the similarity measure.

The registration system 900 includes pre-processing components 910 and 920, and an image comparison component 930. The pre-processing components 910 and 920 are configured to adjust the image data 901 and 902 so that the resulting pre-processed (PP) image data 903 and 904, respectively, have similar voxel distributions (such as voxel spacing and/or values). Example suitable pre-processing techniques include noise reduction, voxel intensity normalization, object filtering, image cropping, and resampling (or re-griding) of the image data 901 and/or 902, among other examples. For example, because the image data 901 and 902 are often captured using different imaging modalities, the image data 901 may have a different range of voxel intensities than the image data 902. For example, intraoperative images may include objects (such as a medical instrument) not found in preoperative images, which can skew their voxel intensity distributions. Thus, in some implementations, the pre-processing components 910 and 920 may adjust the voxel intensities of the image data 901 and 902, respectively, so that the maximum voxel intensity among the pre-processed image data 904 is equal to the maximum voxel intensity among the pre-processed image data 903 and the minimum voxel intensity among the pre-processed image data 904 is equal to the minimum voxel intensity among the pre-processed image data 903. In some other implementations, the pre-processing component 920 (and/or 910) may be configured to detect medical instruments in the image data 902 (and/or 901), using any suitable image processing techniques, and may filter or reduce the intensities of any voxels classified as medical instruments.

In some aspects, the pre-processing component 910 may crop the image data 901 based on the FOV of the second imaging system so that the resulting cropped image data matches the FOV of the image data 902. As shown in FIG. 7, CT imaging systems (used for capturing preoperative images) often have a much larger FOV, and may thus capture more of the anatomy, than CBCT imaging systems (used for capturing intraoperative images). Such differences in FOV can affect a measure of similarity between the images (since the CT image may include myriad anatomical features that are not captured in the CBCT image). Thus, to reduce or minimize the impact of such differences in FOV, the pre-processing component 910 may crop the image data 901 around substantially the same portion of the anatomy that is depicted by the image data 902. Alternatively, or in addition, the pre-processing components 910 and 920 may embed the image data 901 and 902, respectively, into a common image space so that similarity metrics can be computed over a set of voxels of the image data 901 that overlaps with a corresponding set of voxels of the image data 902.

The image comparison component 930 is configured to compare the pre-processed image data 903 with the pre-processed image data 904 and determine the mapping 906 based on the differences between the associated images. For example, the image comparison component 930 may determine a rotation and translation between the images that optimizes a similarity metric. In some implementations, the image comparison component 930 may determine the mapping 906 based on one or more statistical measures of similarity. Example suitable similarity metrics include a cross-correlation metric and a mutual information metric, among other examples. In such implementations, the image comparison component 930 may iteratively rotate and/or translate one of the images relative to the other while measuring the similarity between the images. The rotation and translation that results in the highest measure of similarity may be selected as the mapping 906.

In some other implementations, the image comparison component 930 may determine the mapping 906 based on a machine learning (ML) model 905. Machine learning is a technique for improving the ability of a computer system to perform a certain task. Machine learning generally comprises a training phase and an inferencing phase. During the training phase, a machine learning system is provided with one or more “answers” (also referred to as “ground truth”) and a large volume of raw training data associated with the answers. The machine learning system analyzes the training data to learn a set of rules (also referred to as the “machine learning model”) that can be used to describe each of the answers. During the inferencing phase, the machine learning system may infer answers from new data using the learned set of rules.

In some aspects, the ML model 905 may be trained to infer the mapping 906 based on the pre-processed image data 903 and the pre-processed image data 904. For example, during training, the ML model 905 may learn complex spatial relationships between target images and source images having various degrees of rotation and/or translation relative to one another. More specifically, the ML model 905 may extract multi-scale features from the target and source images to learn a transformation field and a set of parameters (such as a rotation and translation) that can transform the source image to align with the target image for any pair of images depicting the same (or similar) anatomy. During inferencing, the image comparison component 930 may use the ML model 905 to predict a transformation field that transforms the pre-processed image data 904 (representing the source image) into the pre-processed image data 903 (representing the target image). The image comparison component 930 may output the predicted transformations as the mapping 906.

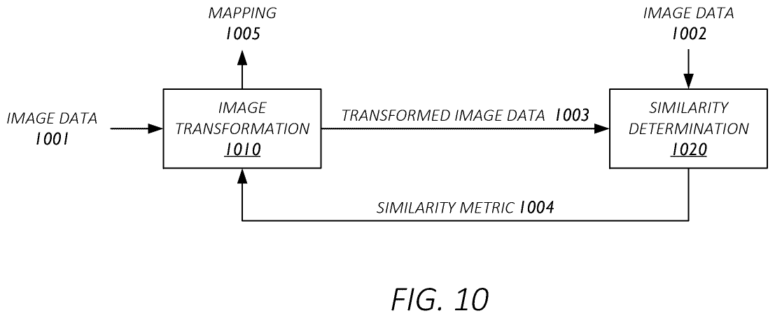

FIG. 10 shows a block diagram of an example image comparison system 1000, according to some implementations. In some implementations, the image comparison system 1000 may be one example of the image comparison component 930 of FIG. 9. More specifically, the image comparison system 1000 is configured to determine a mapping 1005 between a first image space and a second image space based on image data 1001 and 1002, respectively, associated therewith. With reference to FIG. 9, the image data 1001 may be one example of the pre-processed image data 904, the image data 1002 may be one example of the pre-processed image data 903, and the mapping 1005 may be one example of the mapping 906.

The image comparison system 1000 includes an image transformation component 1010 and a similarity determination component 1020. The image transformation component 1010 is configured to selectively and/or iteratively transform the image data 1001 based on a similarity metric 1004. For example, the image transformation component 1010 may apply a rotation and/or translation to the image data 1001 so that the resulting transformed image data 1003 has a different spatial relationship to the image data 1002. In some implementations, the image transformation component 1010 may use the similarity metric 1004 to guide the selection and/or determination of the transformation to be applied to the image data 1001.

The similarity determination component 1020 is configured to calculate the similarity metric 1004 based on the image data 1002 and the transformed image data 1003. More specifically, the similarity determination component 1020 may compare the image data 1002 with the transformed image data 1003 to determine a degree of similarity and/or alignment between the corresponding images. In some aspects, the similarity metric 1004 may be a statistical measure of similarity. Example suitable similarity metrics include a cross-correlation metric and a mutual information metric, among other examples.

In some implementations, the similarity determination component 1020 may measure the cross-correlation between the image data 1002 and the transformed image data 1003. Cross-correlation is a measure of the strength of a linear relationship between two vectors of data. More specifically, the cross-correlation metric ρ_{xy} (also referred to as the “correlation coefficient”) describes the validity of a linear fit between two random variables X and Y:

$${ρ}_{x y} = \frac{cov ( X , Y )}{{σ}_{X} {σ}_{Y}}$$

where cov(X, Y) is the covariance of the variables X and Y, σ_{X} is the standard deviation of X, and σ_{Y} is the standard deviation of Y.

By treating the voxel intensities of the image data 1002 and 1003 as the variables X and Y, respectively, the similarity determination component 1020 can calculate the cross-correlation metric ρ_{xy} using the equation above, where −1≤ρ_{xy}≤1. More specifically, cross-correlation values ρ_{xy} closer to +1 or −1 indicate a stronger linear relationship (in the positive or negative direction) whereas cross-correlation values ρ_{xy} closer to 0 indicate a weaker linear relationship.

In some other implementations, the similarity determination component 1020 may measure the mutual information between the image data 1002 and the transformed image data 1003. Mutual information is a measure of how much knowledge or information can be gained about a random variable X given the value of another random variable Y. More specifically, the mutual information metric I(X;Y) describes how the probability distribution P_{X} of the random variable X differs from the probability distribution P_{Y} of the random variable Y:

$$I ( X ; Y ) = {\sum }_{x y} {P}_{X Y} ( x , y ) log ( \frac{{P}_{X Y} ( x , y )}{{P}_{X} ( x ) {P}_{Y} ( y )} )$$

where P_{XY}(x, y) is the joint probability distribution of X and Y, P_{X}(x) is the marginal probability distribution of X, and P_{Y}(y) is the marginal probability distribution of Y.

By using a joint histogram of voxel intensities between the image data 1002 and the transformed image data 1003 as the joint probability distribution ρ_{XY}(x, y), and using individual histograms of voxel intensities of the image data 1002 and the transformed image data 1003 as the marginal probability distributions P_{X}(x) and P_{Y}(y), respectively, the similarity determination component 1020 can calculate the mutual information metric I(X;Y) using the equation above, where I(X;Y)≥0. More specifically, greater values of I(X;Y) indicate a stronger correlation between the random variables X and Y, whereas values I(X;Y) closer to zero indicate a weaker correlation between the random variables X and Y.

The image transformation component 1010 analyzes the similarity metric 1004 to determine whether to apply a new transformation to the image data 1001. For example, if the similarity metric 1004 indicates a relatively poor fit or alignment between the image data 1002 and the transformed image data 1003 (such as where ρ_{xy} and/or I(X;Y) is close to zero), the image transformation component 1010 may apply a new transformation to the image data 1001. On the other hand, if the similarity metric 1004 indicates a strong fit or alignment between the image data 1002 and the transformed image data 1003 (such as where ρ_{xy} is close to +1 or −1 and/or I(X;Y) is greater than a threshold value), the image transformation component 1010 may output the associated transformation as the mapping 1005. Thus, the image transformation component 1010 may iteratively adjust the transformation applied to the image data 1001 until an optimal transformation is found.

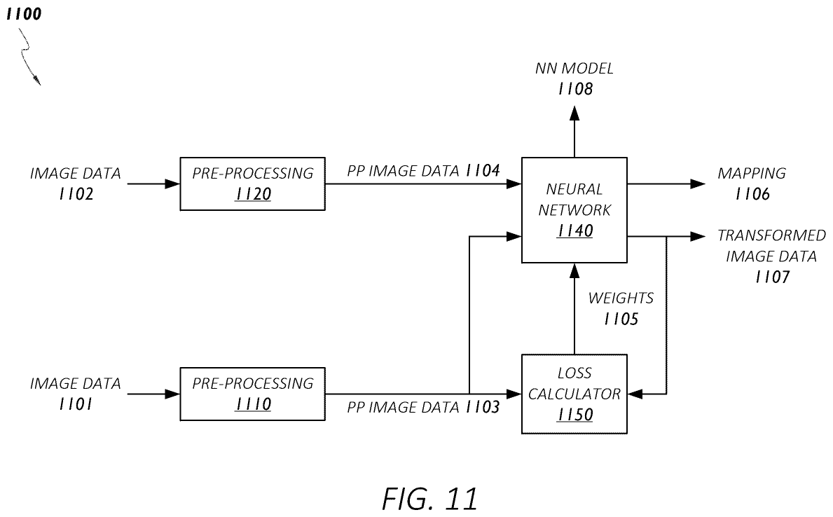

FIG. 11 shows a block diagram of an example machine learning system 1100, according to some implementations. The machine learning system 1100 is configured to produce a neural network (NN) model 1108 based, at least in part, on image data 1101 and 1102 captured via different imaging modalities. In some implementations, the neural network model 1108 may be one example of the machine learning model 907 of FIG. 9. More specifically, the neural network model 1108 may be trained to infer a mapping between a coordinate space associated with a first imaging modality (such as the CT imaging system 310 of FIG. 3) and a coordinate space associated with a second imaging modality (such as the fluoroscopy imaging system 312 of FIG. 3) based on a pair of images captured via each imaging modality.

The image data 1101 may include a large volume of 3D images or tomograms of a particular type of anatomy (such as a lung, kidney, or other suitable anatomy) captured using the first imaging modality. For example, the image data 1101 may be captured via CT scans of the lungs of many different patients at various angles and/or distances. Similarly, the image data 1102 may include a large volume of 3D images or tomograms of the same type of anatomy (as in the image data 1101) captured using the second imaging modality. For example, the image data 1102 may be captured via CBCT scans of the lungs of many different patients at various angles and/or distances. To ensure that an accurate mapping can be found between the different image spaces, image data 1101 may be paired with image data 1102 for the same patient's anatomy. As described with reference to FIG. 9, images associated with different imaging modalities may have different FOVs and/or voxel intensities. In some implementations, the machine learning system 1100 may crop and/or pre-process the image data 1101 and 1102 to reduce or eliminate any discrepancies in FOV and/or voxel intensity between the imaging modalities.

The machine learning system 1100 includes pre-processing components 1110 and 1120, a neural network 1140, and a loss calculator 1150. In some implementations, the pre-processing components 1110 and 1120 may be examples of the pre-processing components 910 and 920, respectively, of FIG. 9. For example, the pre-processing components 1110 and 1120 may adjust the voxel spacing and/or intensities of the image data 1101 and 1102 so that the resulting pre-processed (PP) image data 1103 and 1104, respectively, have similar distributions (such as described with reference to FIG. 9). Example suitable pre-processing techniques include noise reduction, voxel intensity normalization, object filtering, image cropping, and resampling of the image data 1101 and/or 1102, among other examples. In some other implementations, the pre-processing components 1110 and/or 1120 may modify the image data 1101 and/or 1102 (such as through cropping or embedding of the image data into a common image space) so that the pre-processed image data 1103 matches the FOV of the pre-processed image data 1104.

The machine learning system 1100 is configured to train the neural network 1140 to determine the mapping 1106 that transforms the pre-processed image data 1104 into the pre-processed image data 1103. Deep learning is a particular form of machine learning in which the inferencing and training phases are performed over multiple layers. Deep learning architectures are often referred to as “artificial neural networks” due to the manner in which information is processed (similar to a biological nervous system). For example, each layer of an artificial neural network may be composed of one or more “neurons.” Each layer of neurons may perform a different transformation on the output data from a preceding layer so that the final output of the neural network results in the desired inferences. The set of transformations associated with the various layers of the network is referred to as a “neural network model.” Example suitable neural network architectures include convolutional neural networks (CNNs), recurrent neural networks (RNN), and long short-term memory (LSTM) networks, among other examples.

The neural network 1140 receives the pre-processed image data 1104 and 1103, as inputs, and attempts to learn the spatial relationship between their associated image spaces. In some implementations, the neural network 1140 may attempt to transform the pre-processed image data 1104 into the pre-processed image data 1103. For example, the neural network 1140 may form a network of connections across multiple layers of artificial neurons that begin with the pre-processed image data 1104 and 1103 and lead to a set of transformed image data 1107 that reflects a transformation applied to the pre-processed image data 1104. The neural network 1140 also may output an associated mapping 1106 indicating the parameters of the transformation applied to the pre-processed image data 1104. For example, the parameters may be associated with a rigid transform or a non-rigid transform. The connections are weighted to result in transformed image data 1107 that closely resembles the pre-processed image data 1103.

In some aspects, the training may be performed over multiple iterations. In each iteration, the neural network 1140 produces a set of transformed image data 1107 based on weighted connections across the layers of artificial neurons, and the loss calculator 1150 updates the weights 1105 associated with the connections based on an amount of loss (or error) between the transformed image data 1107 and the pre-processed image data 1103. Example suitable loss functions include mean squared error and various similarity metrics (such as cross-correlation, mutual information, or structural similarity index), among other examples. The neural network 1140 may output the weighted connections as the neural network model 1108 when certain convergence criteria are met (such as when the loss falls below a threshold level or when a predetermined number of training iterations have been performed).

The example registration techniques described with reference to FIGS. 6-11 may be used independently, or in combination, to register an intraoperative image space with a preoperative image space (or vice-versa). In some implementations, any number of registration techniques may be combined, in a hierarchical or ordered sequence, to refine the registration. With reference for example to FIG. 11, the neural network model 1108 can provide an initial estimate of the transformation which can be further refined using similarity metrics (such as described with reference to FIG. 10). For example, the image comparison system 1000 of FIG. 10 may use the transformation predicted by the neural network model 1108 as the initial transformation to be applied to the image data 1001 (such as by the image transformation component 1010). In some other implementations, the transformed image data 1003 and/or the similarity metric 1004 produced by the image comparison system 1000 of FIG. 10 may be provided as additional inputs to the neural network 1140 of FIG. 11. Still further, in some implementations, one or more registration techniques may be used to confirm or validate the registration determined using another registration technique.

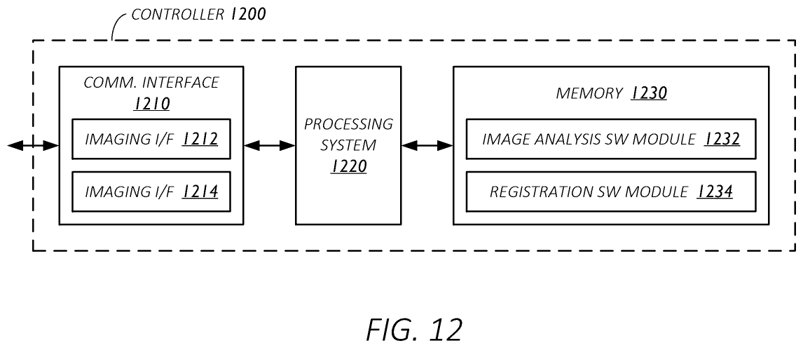

FIG. 12 shows a block diagram of an example controller 1200 for a medical system, according to some implementations. In some implementations, the controller 1200 may be one example of any of the registration systems 600 or 900 of FIGS. 6 and 9, respectively, and/or any of the control circuitry 208 or 224 of FIG. 2. More specifically, the controller 1200 is configured to determine a mapping between different coordinate spaces.

The controller 1200 includes a communication interface 1210, a processing system 1220, and a memory 1230. The communication interface 1210 is configured to communicate with one or more components of the medical system. More specifically, the communication interface 1210 includes a first imaging interface (I/F) 1212 for communicating with a first imaging system (such as the CT imaging system 310 of FIG. 3) and a second imaging interface 1214 for communicating with a second imaging system (such as the fluoroscopy imaging system 312 of FIG. 3). In some implementations, the first imaging interface 1212 may receive first imaging data depicting a first 3D image of an anatomy captured by the first imaging system external to the anatomy, and the second imaging interface 1214 may receive second imaging data depicting a second 3D image of the anatomy captured by the second imaging system external to the anatomy.

The memory 1230 may include a non-transitory computer-readable medium (including one or more nonvolatile memory elements, such as EPROM, EEPROM, Flash memory, or a hard drive, among other examples) that may store the following software (SW) modules: an image analysis SW module 1232 to compare the first image data to the second image data based at least in part on one or more image processing operations; and a registration SW module 1234 to determine a mapping between a first coordinate space associated with the first imaging system and a second coordinate space associated with the second imaging system based on comparing the first image data to the second image data.

The processing system 1220 may include any suitable one or more processors capable of executing scripts or instructions of one or more software programs stored in the controller 1200 (such as in the memory 1230). For example, the processing system 1220 may execute the image analysis SW module 1232 to compare the first image data to the second image data based at least in part on one or more image processing operations. The processing system 1220 may further execute the registration SW module 1234 to determine a mapping between a first coordinate space associated with the first imaging system and a second coordinate space associated with the second imaging system based on comparing the first image data to the second image data.

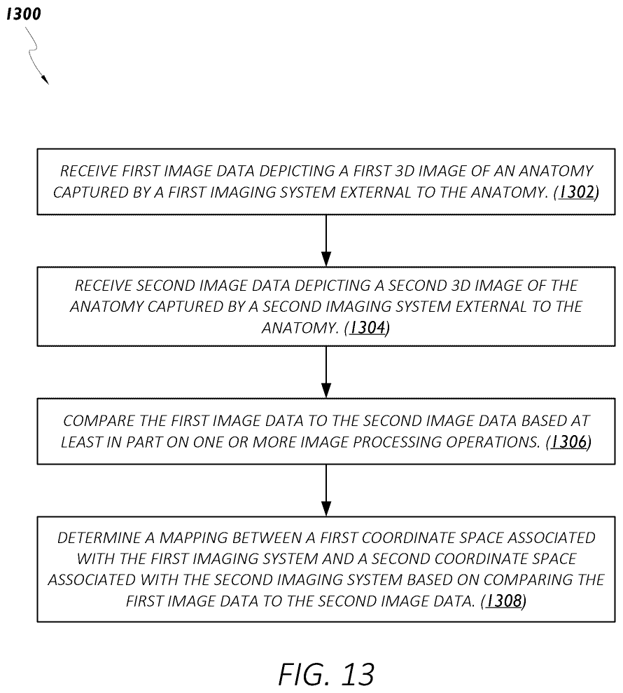

FIG. 13 shows an illustrative flowchart depicting an example operation 1300 for registering different coordinate spaces, according to some implementations. In some implementations, the example operation 1300 may be performed by a controller for a medical system such as the controller 1200 of FIG. 12.

The controller receives first image data depicting a first 3D image of an anatomy captured by a first imaging system external to the anatomy (1302). The controller also receives second image data depicting a second 3D image of the anatomy captured by a second imaging system external to the anatomy (1304). In some implementations, the first imaging system may be a computed tomography (CT) imaging system and the second imaging system may be a cone beam CT (CBCT) imaging system. The controller compares the first image data to the second image data based at least in part on one or more image processing operations (1306). The controller further determines a mapping between a first coordinate space associated with the first imaging system and a second coordinate space associated with the second imaging system based on comparing the first image data to the second image data (1308).

In some aspects, the comparing of the first image data to the second image data may include extracting a plurality of first data points from the first coordinate space based on an image processing operation associated with the first image data, and extracting a plurality of second data points from the second coordinate space based on an image processing operation associated with the second image data, where the mapping is determined based on the plurality of first data points and the plurality of second data points. In some implementations, the image processing operation associated with the first image data may label each voxel of the first image data as belonging to the anatomy or not belonging to the anatomy. In such implementations, the extracting of the plurality of first data points may include interpolating the plurality of first data points based on the voxels of the first image data labeled as belonging to the anatomy.

In some implementations, the image processing operation associated with the second image data may label each voxel of the second image data as belonging to the anatomy or not belonging to the anatomy. In such implementations, the extracting of the plurality of second data points may include interpolating the plurality of second data points based on the voxels of the second image data labeled as belonging to the anatomy. In some implementations, the plurality of first data points may represent a centerline through the anatomy in the first 3D image and the plurality of second data points may represent a centerline through the anatomy in the second 3D image.

In some other implementations, the extracting of the plurality of first data points may include detecting a target within the anatomy based on the first image data, where the plurality of first data points represents a path through the anatomy for an instrument to reach the target and the second 3D image depicts the instrument within the anatomy. In some implementations, the image processing operation associated with the second image data may label each voxel of the second image data as belonging to the instrument or not belonging to the instrument. In such implementations, the extracting of the plurality of second data points may include interpolating the plurality of second data points based on the voxels of the second image data labeled as belonging to the instrument. In some implementations, the plurality of second data points may represent a centerline through the instrument in the second 3D image.

In some other aspects, the second imaging system may have a smaller FOV than the first imaging system. In such aspects, the comparing of the first image data to the second image data may include cropping the first image data based at least in part on the FOV of the second imaging system and comparing the cropped first image data with the second image data, where the mapping is determined based on comparing the cropped first image data with the second image data. In some implementations, the comparing of the cropped first image data with the second image data my include measuring cross-correlation between the cropped first image data and the second image data. In some other implementations, the comparing of the cropped first image data with the second image data may include measuring mutual information between the cropped first image data and the second image data. Still further, in some implementations, the cropped first image data may be compared with the second image data using a neural network model trained to predict the mapping between the first coordinate space and the second coordinate space based on the comparison.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

In the foregoing specification, implementations have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

As used herein, a phrase referring to “at least one of” a list of items refers to any combination of those items, including single members. As an example, “at least one of: a, b, or c” is intended to cover: a, b, c, a-b, a-c, b-c, and a-b-c.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method for registration between different coordinate spaces, comprising:
receiving first image data depicting a first three-dimensional (3D) image of an anatomy captured by a first imaging system external to the anatomy;
receiving second image data depicting a second 3D image of the anatomy captured by a second imaging system external to the anatomy;
comparing the first image data to the second image data based at least in part on one or more image processing operations; and
determining a mapping between a first coordinate space associated with the first imaging system and a second coordinate space associated with the second imaging system based on comparing the first image data to the second image data.

2. The method of claim 1, wherein the first imaging system comprises a computed tomography (CT) imaging system and the second imaging system comprises a cone beam CT (CBCT) imaging system.

3. The method of claim 1, wherein the comparing of the first image data to the second image data comprises:
extracting a plurality of first data points from the first coordinate space based on an image processing operation associated with the first image data; and
extracting a plurality of second data points from the second coordinate space based on an image processing operation associated with the second image data, the mapping determined based on the plurality of first data points and the plurality of second data points.

4. The method of claim 3, wherein the image processing operation associated with the first image data labels each voxel of the first image data as belonging to the anatomy or not belonging to the anatomy, the extracting of the plurality of first data points comprising:
interpolating the plurality of first data points based on the voxels of the first image data labeled as belonging to the anatomy.

5. The method of claim 4, wherein the image processing operation associated with the second image data labels each voxel of the second image data as belonging to the anatomy or not belonging to the anatomy, the extracting of the plurality of second data points comprising:
interpolating the plurality of second data points based on the voxels of the second image data labeled as belonging to the anatomy.

6. The method of claim 5, wherein the plurality of first data points represents a centerline through the anatomy in the first 3D image and the plurality of second data points represents a centerline through the anatomy in the second 3D image.

7. The method of claim 4, wherein the extracting of the plurality of first data points further comprises:
detecting a target within the anatomy based on the first image data, wherein the plurality of first data points represents a path through the anatomy for an instrument to reach the target and the second 3D image depicts the instrument within the anatomy.

8. The method of claim 7, wherein the image processing operation associated with the second image data labels each voxel of the second image data as belonging to the instrument or not belonging to the instrument, the extracting of the plurality of second data points comprising:
interpolating the plurality of second data points based on the voxels of the second image data labeled as belonging to the instrument.

9. The method of claim 8, wherein the plurality of second data points represents a centerline through the instrument in the second 3D image.

10. The method of claim 1, wherein the second imaging system has a smaller field-of-view (FOV) than the first imaging system, the comparing of the first image data to the second image data comprising:
cropping the first image data based at least in part on the FOV of the second imaging system; and
comparing the cropped first image data with the second image data, the mapping determined based on comparing the cropped first image data with the second image data.

11. The method of claim 10, wherein the comparing of the cropped first image data with the second image data comprises:
measuring cross-correlation between the cropped first image data and the second image data.

12. The method of claim 10, wherein the comparing of the cropped first image data with the second image data comprises:
measuring mutual information between the cropped first image data and the second image data.

13. The method of claim 10, wherein the cropped first image data is compared with the second image data using a neural network model trained to predict the mapping between the first coordinate space and the second coordinate space based on the comparison.

14. A controller for a medical system, comprising:
a processing system; and
a memory storing instructions that, when executed by the processing system, cause the controller to:
receive first image data depicting a first three-dimensional (3D) image of an anatomy captured by a first imaging system external to the anatomy;
receive second image data depicting a second 3D image of the anatomy captured by a second imaging system external to the anatomy;
compare the first image data to the second image data based at least in part on one or more image processing operations; and
determine a mapping between a first coordinate space associated with the first imaging system and a second coordinate space associated with the second imaging system based on comparing the first image data to the second image data.

15. The controller of claim 14, wherein the comparing of the first image data to the second image data comprises:
extracting a plurality of first data points from the first coordinate space based on an image processing operation associated with the first image data; and
extracting a plurality of second data points from the second coordinate space based on an image processing operation associated with the second image data, the mapping determined based on the plurality of first data points and the plurality of second data points.

16. The controller of claim 15, wherein the image processing operation associated with the first image data labels each voxel of the first image data as belonging to the anatomy or not belonging to the anatomy, the extracting of the plurality of first data points comprising:
interpolating the plurality of first data points based on the voxels of the first image data labeled as belonging to the anatomy, the plurality of first data points representing a centerline through the anatomy in the first 3D image.

17. The controller of claim 16, wherein the image processing operation associated with the second image data labels each voxel of the second image data as belonging to the anatomy or not belonging to the anatomy, the extracting of the plurality of second data points comprising:
interpolating the plurality of second data points based on the voxels of the second image data labeled as belonging to the anatomy, the plurality of second data points representing a centerline through the anatomy in the second 3D image.

18. The controller of claim 16, wherein the extracting of the plurality of first data points further comprises:
detecting a target within the anatomy based on the first image data, wherein the plurality of first data points represents a path through the anatomy for an instrument to reach the target and the second 3D image depicts the instrument within the anatomy.

19. The controller of claim 18, wherein the image processing operation associated with the second image data labels each voxel of the second image data as belonging to the instrument or not belonging to the instrument, the extracting of the plurality of second data points comprising:
interpolating the plurality of second data points based on the voxels of the second image data labeled as belonging to the instrument, the plurality of second data points representing a centerline through the instrument in the second 3D image.

20. The controller of claim 13, wherein the second imaging system has a smaller field-of-view (FOV) than the first imaging system, the comparing of the first image data to the second image data comprising:
cropping the first image data based at least in part on the FOV of the second imaging system; and
comparing the cropped first image data with the second image data, the mapping determined based on comparing the cropped first image data with the second image data.
